(19) United States
(12) Patent Application Publication
(10) Pub. No.: US 2024/0327194 A1
(43) Pub. Date: Oct. 3, 2024

(54) Auxiliary Fuel Supply System with Multifunctional Configurations

(71) Applicant: McAvey Ventures LLC, Denville, NJ (US)

(72) Inventors: Christian B. McAvey, North Haledon, NJ (US); Michael F. McAvey, Denville, NJ (US); Mark Foyil, Hillsborough, NJ (US)

(21) Appl. No.: 18/623,767

(22) Filed: Apr. 1, 2024

Related U.S. Application Data
(60) Provisional application No. 63/493,853, filed on Apr. 3, 2023.

(51) Int. Cl. B67D 7/04; B67D 7/36; B67D 7/62; B67D 7/84; F02M 37/00; F02M 37/08

(52) U.S. Cl. CPC B67D 7/04; B67D 7/36; B67D 7/62; B67D 7/845; F02M 37/0052; F02M 37/08

(57) ABSTRACT

A temporary fuel supply system for a vehicle that can temporarily circumvent the vehicle's inherent system. The temporary fuel supply system has a fuel input port for receiving fuel and a fuel output port for discharging fuel. The fuel supply system also includes at least one fuel storage container to store fuel, provide fresh fuel and/or store contaminated or old fuel. Inside the system, a pump, pressure regulator, and fuel filters are provided. A first three-way valve selectively connects the second three-way valve to either the fuel input port or to a fuel storage container. A second three-way valve selectively connects the pump to either the first three-way valve or to a fuel storage container. Depending upon how the valves are controlled, the fuel supply system can draw and transfer fuel in a variety or manner to achieve different purposes.

### RELATED APPLICATIONS

This application claims the benefit of U.S. Provisional application No. 63/493,853, filed Apr. 3, 2023.

### BACKGROUND OF THE INVENTION

### 1. Field of the Invention

In general, the present invention relates to auxiliary fuel supply systems that can be used to supply fuel to an engine that is temporarily disconnected from its fuel source. More particularly, the present invention relates to the structure of the auxiliary fuel supply system and its functionality in use.

### 2. Description of the Prior Art

Many types of modern vehicles have a fuel supply system that supplies fuel to an engine either through a carburetor or through fuel injectors. If fuel injectors are used, the fuel is supplied to the fuel injectors at a significant pressure. The operating pressure for different fuel injectors varies for different engine types.

Often when a mechanic is working on a vehicle, the mechanic must disconnect the fuel supply system from the engine to diagnose a problem, replace a defective part, conduct maintenance, add a modification, or simply to provide room to conduct some other repair. When the fuel supply system is disconnected from an engine, the engine has no fuel supply, and the engine cannot start. As a consequence, to determine if the work performed on the vehicle has been successful, the fuel supply system must be reinstalled. If the work performed on the vehicle was not successful, or requires further adjustment, the fuel supply system must be uninstalled again, and the process repeated. This process consumes time, therein making the mechanic less efficient and the work more expensive.

For example, if the work being performed is on a motorcycle, then there are further complexities to the process. Due to the limited space on a motorcycle, the engine and battery are located in the area under the gas tank and seat. The gas tank is exposed and often has a very expensive paint scheme. To perform many types of repairs, modifications, replacements, and maintenance on the motorcycle, the gas tank is commonly removed. Once removed, the gas tank must be drained or plugged. The gas tank is then wrapped and stored to prevent damage to the expensive paint scheme. With the gas tank removed, the battery is also often removed or disconnected. The result is a vehicle with no fuel and no electrical power. To test the motorcycle after repair, the battery and fuel system must be reinstalled and/or reconnected, while taking great care not to damage the painted gas tank. The fuel tank must be refilled, and the fuel lines bled of air. The gas tank must be repeatedly removed and reinstalled until the work being performed is finalized. Likewise, it is often necessary to repeatedly disconnect and connect the battery. Often the time it takes to both remove and secure the gas tank and disconnect and reconnect the battery is significantly longer than the time it takes to conduct the actual repair, replacement, modification, or maintenance.

In the prior art there are auxiliary fuel supply systems that can be attached to a vehicle when the onboard fuel system is disconnected. Such systems are exemplified by U.S. Pat. No. 9,914,633 to McAvey. These auxiliary fuel supply systems are primarily designed for cars and trucks and are difficult to adapt for use on motorcycles. Such systems only supply fuel from a gas can and have no other abilities, such as the ability to drain a gas tank or the ability to provide fuel from a secondary source.

A need therefore exists for an improved fuel supply system that is particularly well adapted for servicing motorcycles and like vehicles, wherein the fuel supply system can help drain a gas tank, fill a gas tank and/or draw fuel from a secondary source. This need is met by the present invention as described and claimed below.

### SUMMARY OF THE INVENTION

The present invention is a temporary fuel supply system for a vehicle that can temporarily circumvent the fuel supply system that is inherent in the vehicle. In this manner, certain tests, modifications, repairs, and maintenance can be performed while the inherent fuel supply system is disconnected from the vehicle engine. The temporary fuel supply system is preferably mounted on a cart so that it can be wheeled to a vehicle when needed. The temporary fuel supply system has a fuel input port for receiving fuel and a fuel output port for discharging fuel. The fuel supply system also includes at least one fuel storage container to store fuel, provide fresh fuel and/or store contaminated or old fuel.

Inside the fuel supply system, a pump and pressure regulator are provided. Valves are also provided and preferably include a first three-way valve and a second three-way valve. The first three-way valve selectively connects the second three-way valve to either the fuel input port or to a fuel storage container. The second three-way valve selectively connects the pump to either the first three-way valve or to a fuel storage container. Depending upon how the valves are controlled, the fuel supply system can transfer fuel directly from the fuel input port to the fuel output port. Alternatively, fuel can be transferred from the fuel input port to the fuel output port with a layover in a fuel storage container. Alternatively, contaminated fuel can be drained through the input port and held in a fuel storage container, while stored fresh fuel is supplied to the output port.

The fuel supply system can also contain a battery and jumping leads. This enables the fuel supply system to provide electrical power to a vehicle that has its own battery that may be uncharged, removed or disconnected.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is an exemplary embodiment of the present invention fuel supply system shown in conjunction with a motorcycle that has its gas tank and battery removed;

FIG. 2 is a schematic illustrating the functional components of the fuel supply system of FIG. 1;

FIG. 3 is a partial schematic illustrating a first configuration for the fuel supply system used in directing fresh fuel from an external fuel source to an engine;

FIG. 4 is a partial schematic illustrating a second configuration for the fuel supply system used in substituting old fuel with fresh fuel when supplying an engine;

FIG. 5 is a partial schematic illustrating a third configuration for the fuel supply system used in transferring fuel between two vehicles;

FIG. 6 is a partial schematic illustrating a fourth configuration for the fuel supply system used in pumping fuel on demand; and

FIG. 7 is an alternate exemplary embodiment of the present invention fuel supply system.

### DETAILED DESCRIPTION OF THE DRAWINGS

Although the present invention mobile fuel supply system can be configured in many ways and can be used to supply fuel to many types of vehicles, the present invention is especially well suited for servicing motorcycles, ATVs, scooters and the like that require some disassembly or fuel line disconnections to access various engine parts. Accordingly, the present invention is illustrated and described in conjunction with a motorcycle in order to set forth one of the best modes contemplated for the invention. However, the illustrated embodiment is only intended to be exemplary and should not be considered as limiting other possible embodiments of the invention covered within the scope of the claims.

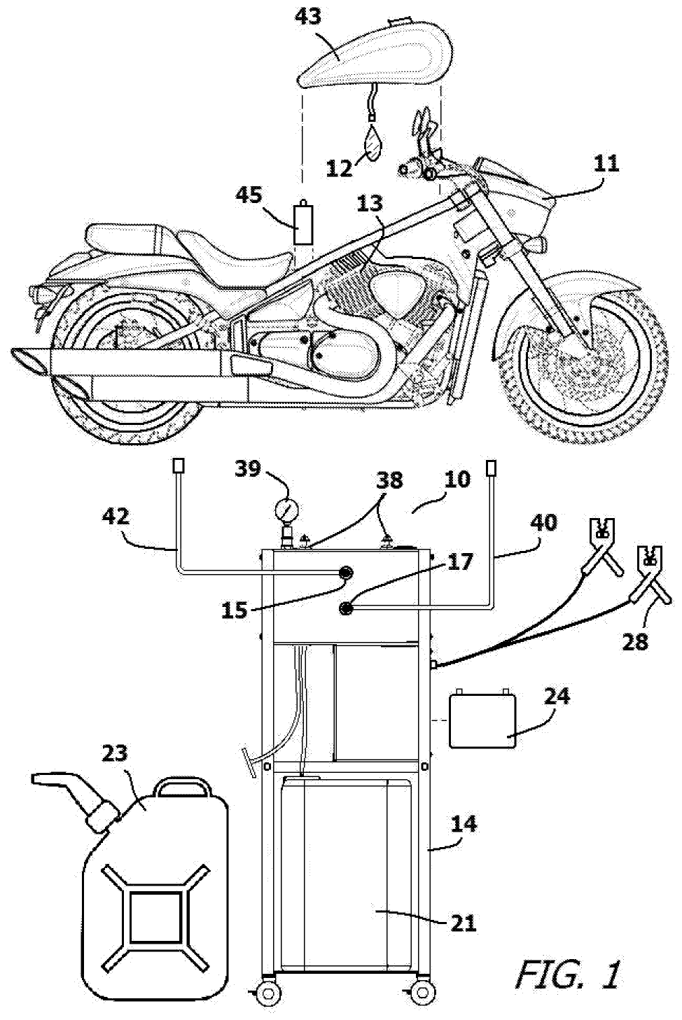

Referring to FIG. 1, a mobile fuel supply system 10 is shown in conjunction with a vehicle 11. The vehicle 11 shown is a motorcycle. However, any other vehicle, such as a car, truck, or ATV could also be serviced. The purpose of the mobile fuel supply system 10 is to provide fuel and/or electrical power to an engine 13 so that the engine 13 can be run without the need of the electrical power and/or fuel supply system present in the vehicle 11. The mobile fuel supply system 10 can be used to supply fuel 12 under pressure directly to fuel injectors or to a carburetor. The fuel supplied can be supplied at the pressure required by the engine 13 of the vehicle 11. As will be explained, the mobile fuel supply system 10 can be configured in diverse ways to perform distinct functions. The functions include, but are not limited to, supplying fuel to an engine, draining fuel from a gas tank, transferring fuel between vehicles, and providing electrical power.

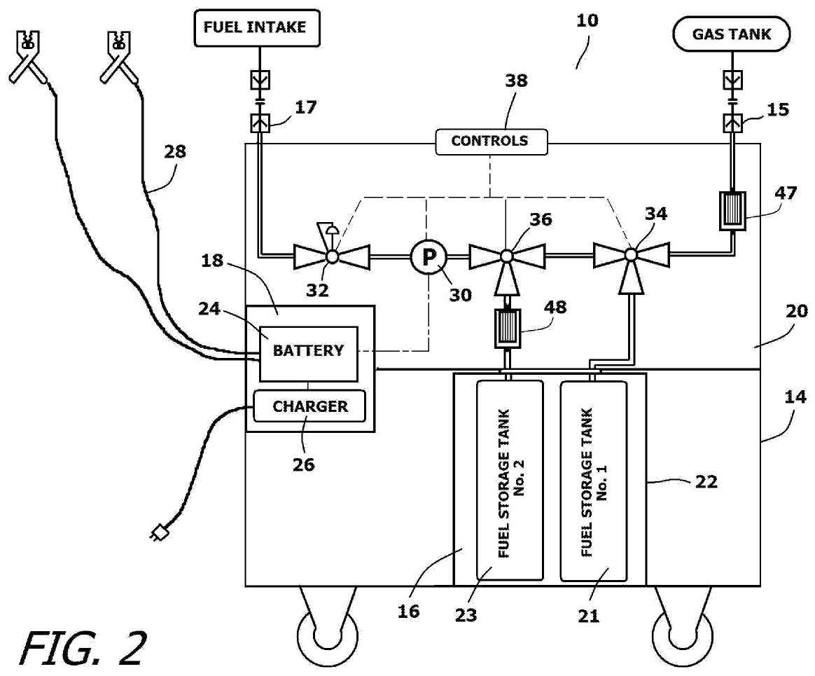

Referring to FIG. 2 in conjunction with FIG. 1, it can be seen that the mobile fuel supply system 10 is preferably mounted in a cart 14 so that it can be wheeled to the vehicle 11. The cart 14 supports an input port 15 for receiving fuel 12 from an external source, and an output port 17 for providing fuel 12 to an external source. For the purposes of safety, the cart 14 is preferably metal and is divided into separate distinct compartments 16, 18, 20. A first compartment 16 is provided at the bottom of the cart 14 for fuel storage. This first compartment 16 can hold either one large fuel storage container or two smaller fuel storage containers for purposes later explained. The compartment is generally open to provide easy access to the fuel storage containers. In FIG. 1 and FIG. 2, the use of two fuel storage containers 21, 23 is shown. Although the two fuel storage containers 21, 23 may be provided as part of the overall system 10, it is preferred that the system 10 be sold with one fuel storage container 21. The second fuel storage container 23 can be any existing gas can owner by the user.

The second compartment 18 is a battery compartment for holding a 12-volt vehicle battery 24. The battery 24 is used to power the mobile fuel supply system 10. In this manner, the system 10 can be used at locations where grid power is unavailable. An optional charger 26 can be provided so that the battery 24 can be periodically charged when grid power is available. In place of the charger 26, a connection can be provided so that the battery can be periodically connected to an external battery charger.

Optional battery jumping leads 28 can be provided that extend out of the second compartment 18. The battery jumping leads 28 can be used to charge the battery 24. Alternatively, the battery jumping leads 28 enable the battery 24 to be connected to the vehicle 11, therein providing electrical power to the vehicle 11. The second compartment 18 is isolated to prevent any sparks that may occur near the battery 24 from effecting anything outside the second compartment 18.

The third compartment 20 is at the top of the cart 14 and contains various components for selectively moving the fuel 12. The third compartment 20 holds a pump 30, a pressure regulator 32 for controlling the output pressure of the pump 30, and two separate three-way valves 34, 36 that selectively control the flow of the fuel 12. The first three-way valve 34 can connect the input port 15 to either the first fuel storage container 21 or to the second three-way valve 36. The second three-way valve 36 can take input from either the first three-way valve 34 or from the second fuel storage container 23 and direct the fuel 12 to the output port 17. Controls 38 are provided to operate the pump 30, the pressure regulator 32, the first three-way valve 34 and the second three-way valve 36. The controls 38 are present on the exterior of the cart 14 and can be either manual controls or electronic controls. The control 38 can also include one or more gauges 39 to visualize the pressure of the fuel being provided to the output port 17.

Various connector leads 40, 42 are provided for connecting the input port 15 and the output port 17 to the fuel system of the vehicle 11. The connector leads 40, 42 are specifically designed to connect to the fuel system of a vehicle 11. Such connection leads are exemplified by U.S. Pat. No. 9,914,633 to McAvey, the disclosure of which is herein incorporated by reference.

In the shown embodiment, it will be understood that to access the fuel injector or carburetor of a motorcycle, the motorcycle gas tank 43 and motorcycle battery 45 may need to be removed. With the motorcycle gas tank 43 and the motorcycle battery 45 removed or disconnected, the engine 13 may have no fuel source or electrical power source. The mobile fuel supply system 10 is brought into proximity with the motorcycle. The battery jumping leads 28 from the mobile fuel supply system 10 are attached to the motorcycle, therein providing the motorcycle with electrical power, if needed.

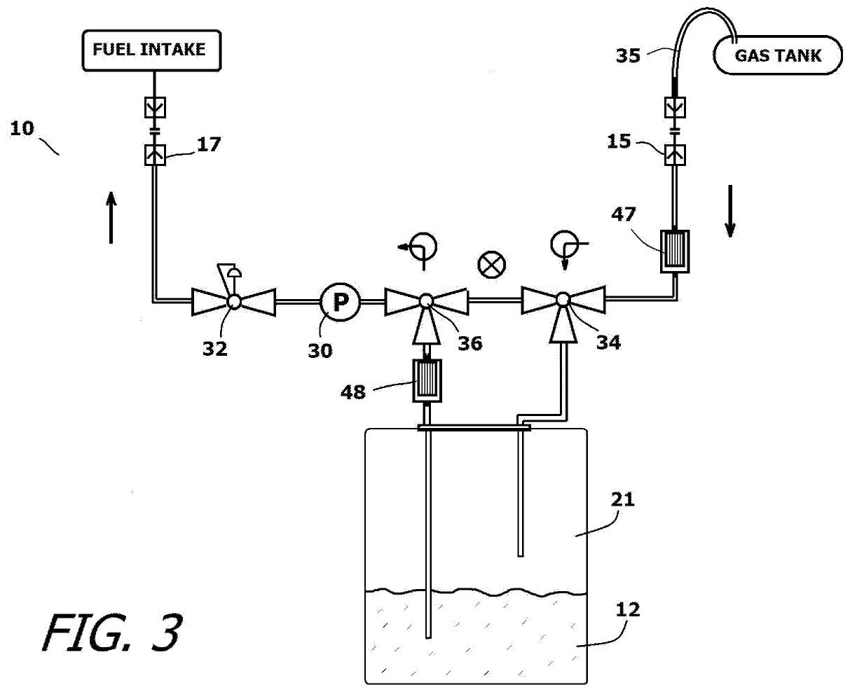

Referring to FIG. 3 in conjunction with FIG. 1, a basic repair configuration is shown. In this configuration, it can be assumed that the fuel 12 in the motorcycle gas tank 43 is fresh. Since the fuel 12 can be reused, only one fuel storage container 21 needs to be provided. The input port 15 of the mobile fuel supply system 10 is supplied with fuel 12 from the motorcycle gas tank 43. This can be done either before or after the motorcycle gas tank 43 is removed. Preferably, the fuel 12 is accessed by providing a drain tube 35 that can be extended into the motorcycle gas tank 43 through its large refuelling opening. The drain tube 35 connects to the input port 15.

The first three-way valve 34 is configured to direct the fuel 12 into the fuel storage container 21. The pump 30 is activated to empty the motorcycle gas tank 43. The fuel 12 passes through a first filter 47 to prevent the transfer of any impurities. Once the motorcycle gas tank 43 is empty, the motorcycle gas tank 43 can be safely wrapped and stored in a safe location. The fuel storage container 21 is now at least partially filled with fuel 12. If the motorcycle gas tank 43 was empty or near empty, extra fresh fuel can be added to the fuel storage container 21.

The needed work is to the motorcycle, and the fuel intake of the motorcycle is connected to the output port 17 of the mobile fuel supply system 10. Once complete, the first three-way valve 34 is closed, and the second three-way valve 36 is configured to connect the pump 30 to the fuel storage container 21. The pump 30 is activated. The pump 30 draws the fuel 12 out of the fuel storage container 21 and through a second filter 48. The fuel 12 passes through the pressure regulator 32, wherein the pressure regulator 32 is set to match the operating pressure required by the motorcycle. Accordingly, the pressure regulator 32 provides fuel to the motorcycle at the pressure required by the fuel intake system. The motorcycle can then be started using the power from the battery 24. The motorcycle need not be reassembled. Once started, or a start is attempted, the work done to the motorcycle can be evaluated. If the work performed was proper, the mobile fuel supply system 10 can be disconnected and the motorcycle reassembled.

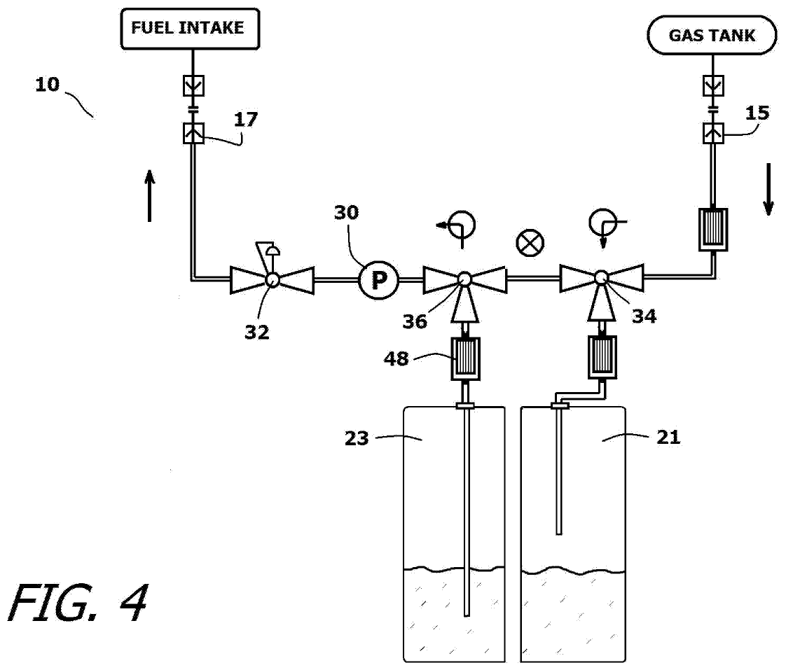

Referring to FIG. 4 in conjunction with FIG. 1 and FIG. 2, an alternate configuration is shown for use on a motorcycle that has old fuel or contaminated fuel. In this situation, two fuel storage containers 21, 23 are used. The first fuel storage container 21 is part of the system 10 and the second fuel storage contain 23 is preferably a gas can intended to hold old fuel. The input port 15 of the mobile fuel supply system 10 receives fuel from the motorcycle gas tank 43. This can be done either before or after the motorcycle gas tank 43 is removed. The first three-way valve 34 is configured to direct old fuel into the second fuel storage container 23. The pump 30 is activated to empty the motorcycle gas tank 43. Once the motorcycle gas tank 43 is empty, the motorcycle gas tank 43 can be safely wrapped and stored in a safe location and the needed work is done to the motorcycle.

The fuel intake of the motorcycle is connected to the output port 17 of the mobile fuel supply system 10. Once complete, the first three-way valve 34 is closed, and the second three-way valve 36 is configured to connect the pump 30 to the second fuel storage container 23 that contains fresh fuel. The pump 30 is activated. The pump 30 draws fresh fuel out of the first fuel storage container 21 and through the second filter 48. The fuel passes through a pressure regulator 32, wherein the pressure regulator 32 is set to match the operating pressure required by the motorcycle. The motorcycle can then be started using the power from the battery 24. The motorcycle need not be reassembled. Once started, or a start is attempted, the work done to the motorcycle can be evaluated. If the work performed was proper, the mobile fuel supply system 10 can be disconnected and the repaired motorcycle reassembled.

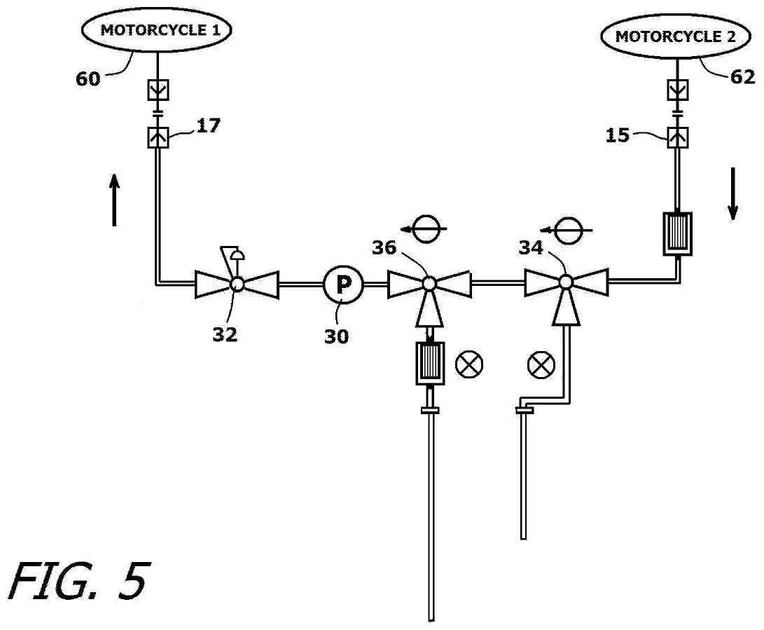

Referring to FIG. 5 in conjunction with FIG. 2, an alternate configuration is shown for use on a first motorcycle 60 that is receiving fuel directly from a second motorcycle 62. In this situation, no fuel storage containers are required. The input port 15 of the mobile fuel supply system 10 receives fuel from the gas tank of the second donor motorcycle 62. The first three-way valve 34 is configured to direct fuel to the second three-way valve 36. The fuel intake of the first motorcycle 60 is connected to the output port 17 of the mobile fuel supply system 10. Once complete, the second three-way valve 36 is configured to supply fuel to the pump 30. The pump 30 is activated. The pump 30 draws fuel out of the second donor motorcycle 62. The fuel passes through the pressure regulator 32, wherein the pressure regulator 32 is set to match the operating pressure required by the first motorcycle 60. If needed, the first motorcycle 60 can then be started using the power from the battery 24. The mobile fuel supply system 10 can then be disconnected.

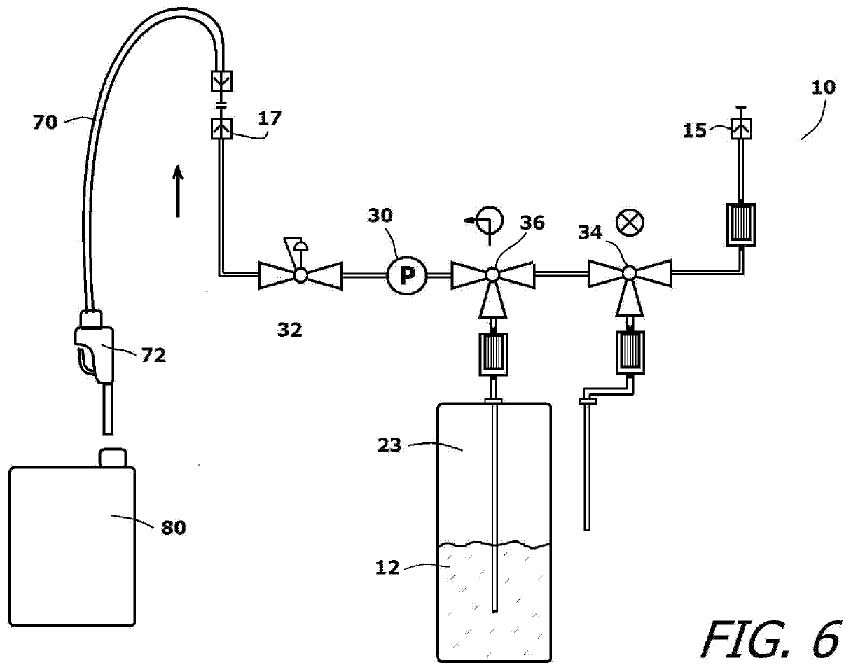

Referring to FIG. 6, an alternate configuration is shown for using the mobile fuel supply system 10 as a fuel pump. In this situation, a single fuel storage container 23 is required. The input port 15 of the mobile fuel supply system 10 is left unconnected. The first three-way valve 34 is closed. The second three-way valve 36 is configured to connect the pump 30 to the fuel storage container 23. The pressure regulator 32 is set to fully open. The pump 30 is activated. The pump 30 draws fuel out of the fuel storage container 23 and directs the fuel to the output port 17. A hose 70 with a fill nozzle 72 is connected to the output port 17. The hose 70 and fill nozzle 72 can then be used to external fill gas tanks 80.

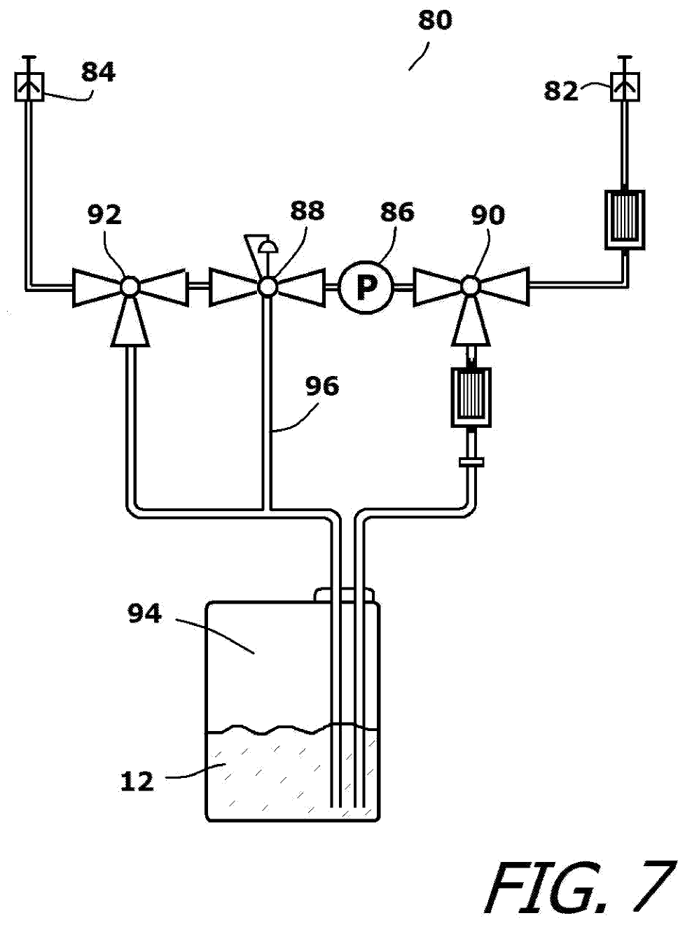

Referring to FIG. 7, an alternate embodiment of fuel supply system 80 is shown that has a configuration slightly different from that previously described. The fuel supply system 80 moves fuel 12 between a fuel input port 82 and a fuel output port 84 using the same components as have been described. However, in this embodiment, the components are arranged differently to provide alternate operational functions.

In the configuration of FIG. 7, the fuel supply system 80 contains a pump 86, a pressure regulator 88 for controlling the output pressure of the pump 86, and two separate three-way valves 90, 92. The first three-way valve 90 can connect the input port 82 to either a fuel storage container 94 or to the pump 86. The second three-way valve 92 can take input from either the pressure regulator 88 or from the fuel storage container 94, wherein the second three-way valve 92 directs the fuel 12 to the output port 84.

The pump 86 and the pressure regulator 88 are disposed between the first three-way valve 90 and the second three-way valve 92. The pressure regulator 88 is set for a wanted output pressure. If the pump 88 supplies fuel 12 at any pressure above the selected output pressure, the fuel 12 is directed to a bypass 96 that leads back to the fuel storage container 94.

When the first three-way valve 90 connects the pump 86 to the input port 82 and the second three-way valve 92 is closed, the pump 86 draws fuel 12 from the input port 82. The fuel 12 flows through the bypass 96 and into the fuel storage container 94. In this manner, fuel 12 can be drained from a gas tank or other external source and held in the fuel storage container 94.

When the first three-way valve 90 is closed and the second three-way valve 92 connects the pump 86 to the output port 84, the pump 86 draws fuel 12 from the fuel storage container 94. The fuel 12 is directed to the output port 84 and can be used to fill some external gas tank. Likewise, a connector can be attached to the output port 84 and the fuel 12 can be supplied to the fuel intake of a vehicle at a pressure controlled by the pressure regulator 88.

When the first three-way valve 90 connects the pump 86 to the input port 82 and the second three-way valve 92 connects the pump 86 to the output port 84, fuel 12 can be transferred from one vehicle to another without the fuel flowing into the fuel storage container 94.

Lastly, with the first three-way valve 90 connecting the fuel storage container 94 to the pump 86 and the second three-way valve 92 connecting the pump 86 back to the fuel storage container 94, the fuel 12 in the fuel storage container 94 can be recirculated. This is useful for aerating the fuel and/or mixing additives with the fuel 12.

It will be understood that the embodiments of the present invention that are illustrated and described is merely exemplary and that a person skilled in the art can make many alternate embodiments. All such variations, modifications and alternate embodiments are intended to be included within the scope of the present invention as defined by the claims.

What is claimed is:

1. A fuel supply system, comprising:
a fuel input port;
a fuel output port;
at least one fuel storage container;
a pump having a pump output directed to said fuel output port, wherein said pump output has an output pressure;
a pressure regulator for selectively controlling said output pressure;
a first three-way valve;
a second three-way valve;
wherein said first three-way valve selectively connects said second three-way valve to either said fuel input port or said at least one fuel storage container; and
wherein said second three-way valve selectively connects said pump to either said first three-way valve or to said at least one fuel storage container.

2. The fuel supply system according to claim 1, further including a battery for powering said pump.

3. The fuel supply system according to claim 2, further including a mobile cart, wherein said battery, said at least one fuel storage container, said pump, said pressure regulator, said first three-way valve and said second three-way valve are supported by said mobile cart.

4. The fuel supply system according to claim 3, wherein said mobile cart contains a first compartment for holding said at least one fuel storage container, a second compartment for holding said battery, and a third compartment for holding said pump, said pressure regulator, said first three-way valve and said second three-way valve.

5. The fuel supply system according to claim 4, wherein said at least one fuel storage container is selectively removable from said first partitioned compartment of said mobile cart.

6. The fuel supply system according to claim 1, wherein said at least one fuel storage container includes a first storage container and a separate second storage container, wherein said said first three-way valve selectively connects to said first fuel storage container and said second three-way valve selectively connects to said second fuel storage container.

7. A fuel supply system, comprising:
a mobile cart having a compartment for receiving at least one removable fuel storage container;
a fuel input port;
a fuel output port;
a pump having a pump output directed to said fuel output port, wherein said pump output has an output pressure;
a pressure regulator for selectively controlling said output pressure;
valves for selectively connecting said fuel input port and said fuel output port to each other and said at least one fuel storage container, wherein said valves have valve controls exposed on said cart.

8. The fuel supply system according to claim 7, further including a battery supported in said cart, wherein said battery powers said pump.

9. The fuel supply system according to claim 8, wherein said cart contains a first compartment for holding said at least one fuel storage container, and a second compartment for holding said battery, wherein said second compartment is isolated from said first compartment.

10. The fuel supply system according to claim 7, wherein said valves include a first three-way valve and a second three-way valve, wherein said pump is disposed between said first three-way valve and said second three-way valve.

11. The fuel supply system according to claim 10 wherein said first three-way valve selectively connects said pump to either said fuel input port or said at least one fuel storage container,

12. The fuel supply system according to claim 11, wherein said second three-way valve selectively connects said pump to either said fuel output port or said at least one fuel storage container.

13. The fuel supply system according to claim 7, wherein said valves include a first three-way valve and a second three-way valve, wherein said first three-way valve selectively connects said second three-way valve to either said fuel input port of said at least one fuel storage container.

14. A method of operating a fuel supply system, comprising the steps of:
providing a mobile fuel supply system having a fuel input port, a fuel output port, a pump, a pressure regulator, and valves for selectively connecting said input port and said output port to each other and at least one fuel storage container;
connecting said fuel input port to a gas tank of a vehicle;
connecting said fuel output port to a fuel intake within said vehicle; and
operating said pump to direct fuel from said gas tank to said fuel intake.

15. The method according to claim 14, further including utilizing said pump to supply said fuel to said output port.

16. The method according to claim 15, wherein said mobile fuel supply system includes a first fuel container and a second fuel container, wherein said pump draws said fuel into said first fuel container.

17. The method according to claim 16, further including at least partially filling said second fuel container with fresh fuel and utilizing said pump to pump said fresh fuel to said output port.

18. The method according to claim 14, wherein said pump draws said fuel from said gas tank and transfers said fuel to a removable fuel container, and wherein said pump draws said fuel from said removable fuel container and supplies said fuel to said output port.

19. The method according to claim 14, further including providing a battery as part of said mobile fuel supply system, and electrically connecting said battery to said vehicle.

20. The method according to claim 14, wherein said mobile fuel supply system includes a wheeled cart.
